(19) United States
(12) Patent Application Publication
(10) Pub. No.: US 2004/0215475 A1
(43) Pub. Date: Oct. 28, 2004

(54) Labour scheduling program

(76) Inventors: William Maglaris, Adelaide (AU); Anthony Hogan, Adelaide (AU); Stephen Schmid, Adelaide (AU)

Correspondence Address: AKERMAN SENTERFITT, P.O. BOX 3188, WEST PALM BEACH, FL, 33402-3188, US

(21) Appl. No.: 10/483,316

(22) PCT Filed: Jul. 9, 2002
(86) PCT No.: PCT/AU02/00908

(30) Foreign Application Priority Data
Jul. 9, 2001 (AU) PR 6203

(51) Int. Cl. G06F 17/60

(52) U.S. Cl. 705/1

(57) ABSTRACT

A computer program for scheduling of rosters of employees or contractors which program includes financial data so that actual value of sales on a unit of time basis for past periods, and the cost of wages incurred by reason of a selected schedule of personnel scheduled are provided. Also disclosed is the ability to test the cost of any schedule proposal in the future.

### TECHNICAL FIELD

This invention is directed to an arrangement to assist in the management of a workforce where scheduling of various personnel is required.

### BACKGROUND ART

This invention is directed to the problem that apart from simply scheduling, significant costs result in many industries from a selection of specific personnel and especially their cost per unit of time compared to competency so that with appropriate allocation of personnel some savings can result which may be of significance.

An object of this invention is to provide through a software program a tool that can be of significant benefit in cost saving in relation to scheduling.

### DISCLOSURE OF THE INVENTION

In one form of this invention this can be said to reside in a computer program for use in a computer such that when in a computer with a visual display unit and data entry means there are means in the computer to store a wage cost per unit of time for each of selected employee or contracted personnel, and an output screen available and means to effect calculations so that there will be displayed on the display unit in accord with input data, actual value of sales on a unit of time basis for each of at least one past day, and the cost of wages incurred by reason of a schedule of personnel scheduled in the program as a result of input from a user.

In preference in the alternative there is available for a further at least one day in the future an estimate of the cost of wages if scheduled allocations are used.

In preference in the alternative there is, in relation to the display unit, an extent to which a wage cost result has achieved in the one case, and could achieve in the other, a budget prediction these being then for historic sales and for predicted sales for selected ranges of time.

In preference in the alternative it is programmed to effect calculations in relation to preset limits such that if a result is below a budget expectation then there will be a warning message on a further available display screen.

In preference in the alternative the program is arranged to provide and calculate any budget predictions both as a direct cost and as a percentage of sales.

In preference in the alternative the program provides as an available output a cost for a roster period not only by area or department, but also a total for an entire business.

In preference in the alternative the program captures and stores rosters completed at the end of their period.

In preference in the alternative t it is further adapted such that when a history is built up, the historical information can be viewed and be used for comparison purposes.

In preference in the alternative the program is adapted to facilitate setting up rosters to reflect a desired average age consistently over financial periods.

In preference in the alternative the program value of sales as both monetary value and percentage of value of wage cost.

In preference in the alternative the program further includes means to provide either as a visual display output or a print output, at any stage, daily results achieved together with the budgeted outcome forecast for a selected period.

In preference in the alternative the program further adapted to effect accessible data records to include employee or contractor details which includes as applicable for each person information for that person relating to availability, annual leave, pay rate per unit of time, age, demographic details and areas of competency.

In preference in the alternative the program is further arranged to provide that either click and drag timelines in a chart view or allocated times in grid view are available.

In preference in the alternative the program is further arranged so that as shifts are built, cost of wages details are displayed.

In preference in the alternative it is further arranged such that when a schedule is being built there is an option for the user to display only employee or contractor lists in relation to employees or contractors available and qualified for the particular shift

In preference in the alternative if a selection list of available employees or contractors does not provide coverage, there is a manual override which can be used to view all available staff regardless of qualification.

In preference in the alternative to create a roster for any given period, the user may choose from 1) a saved shift selection; 2) an existing roster either current or pending; or 3) a previously completed roster.

In preference in the alternative there is a printout able to be generated which is an actual hours master list report at the end of any period both in relation to employee in the one case and location in the other.

In preference in the alternative there is provided in combination a computer programmed with a program.

In preference in the alternative the invention can be said to reside in a method of building a schedule which includes the steps of running a computer program in a computer where the program is as in any one of the preceding claims, inputting data into the program relevant to employees or contractors and the times and areas required to be manned and then testing each of a proposed schedule to test whether such a proposal will provide a best economic fit.

An embodiment of this invention is directed to managers of workforces of, in preference, between 20 and 200 people.

An embodiment of this invention has for its purpose to provide a program that will assist but not take over the rostering system.

An embodiment of this invention therefore provides a “Managers Tool”. The “HANDS ON” manager by using his knowledge of their workforce with the aid of an embodiment of this invention, to both create and monitor typically daily labor costs, will potentially save significant costs.

An embodiment of this invention can save a manager untold hours creating, adjusting and above all costing and monitoring rosters, releasing them to other equally important tasks. The manager using an embodiment of this invention will be in a better position to have an in-depth knowledge of labour status daily, rather than after the reporting period.

An embodiment of this invention provides a cost for a roster period not only by area or department, but also the bottom line for the entire business. At any stage of the roster process, it can be updated to ensure accuracy. This is particularly useful in cases of illness, absenteeism, or in the case of addition of staff to react to an increased need.

An embodiment of this invention captures and stores rosters completed at the end of their period. When a history is built up, the information can be pulled up and used in comparison at the click of a button. Managers find this invaluable in keeping a handle on seasonal and annual trends.

An embodiment of this invention can be set-up to monitor age if this is a consideration to an industry. (Particularly relevant to food preparation and service, to name just one.) By setting up rosters to reflect the desired average age consistently over financial periods is how significant savings can be made.

An embodiment of this invention allows the results to be monitored daily, and constantly one can be aware of the cumulative outcome for the week, giving the manager superior control of the outcome.

Sales information is reported with both $ and % considerations to wage cost. At any stage of the process the daily results achieved together with the budgeted outcome forecast are available immediately. If requested, in the middle of a week, the combination of actual and forecast is used to show the weekly cumulative result. This means that the user can adjust the roster on a daily basis to ensure that the forecast outcome is achieved either from a dollar limit perspective, or from a wage cost vs sales percentage. This ensures that the manager will be assisted to achieve or beat his budget, saving the company from “blowout” at all times.

Employee details are captured and managed by an easy to use interface which includes information including availability, annual leave, pay per unit of time, age, demographic details and areas worked. These details are the building blocks for rosters and can be updated with ease. Calendar specific information (i.e. birth date) is updated automatically. The identification of cross-training opportunities is easy as managers periodically peruse the screen.

Shifts are important to the identification of the most cost efficient mix of employee types and work times. Shifts may be permanent or one off's for particular occasions. Allocation of shifts is simple, the program is arranged so that either click and drag timelines in chart view or allocate times in grid view are available. Shifts may be for a particular day or selected as a format for other days. As shifts are built, cost details are displayed on bottom status bar. When the manager is happy with the levels, the shift set is ready to be named and saved, ready to have employees allocated to become a roster.

Rosters are finalized when a manager chooses employees from the available list for the shift. Employee lists displayed, only contain employees available and qualified for the particular shift. If the selection list does not provide coverage, manual overrides can be used to view all available staff regardless of qualification. This clearly flags to the manager that staff resources need to be topped up. To create a roster for any given period, the manager may choose from 1) a saved shift selection; 2) an existing roster either current or pending; or 3) a previously completed roster.

These flexibilities in creating a roster ensure that the managers' desired outcomes are achievable in the quickest time, whilst still providing them all of the appropriate choices.

A Wage Cost Status Report display is a budget's watchdog. It flags the results of a roster daily and also calculates these results with projections to show a forecasted likely outcome-sales vs wage cost. This is the report which can prompt managers to action changes as appropriate to ensure that set targets are met. An embodiment of this invention means that rosters can be changed at any time during the period and updates all facets immediately upon being changed.

This embodiment of this invention provides managers with a comprehensive suite of reports tailored to present with clarity 1) the system settings status; 2) the latest cost setting status; 3) the employee status and detail; and above all 4) all past, present and projected sales and wage cost status details ensuring knowledge of the labor position.

### BRIEF DESCRIPTION OF THE DRAWINGS

For a better understanding of this invention it will now be described with the assistance of drawings which are illustrations of display screens of a computer program according to the embodiment:

FIG. 1 is the display of a wage cost status report including actual and estimated figures and comparisons of actual against budgeted proposals;

FIG. 2 is a display screen illustrating typically warnings that are generated within the program during its use;

FIG. 3 illustrates an employee's personal details screen including in pictorial layout availability;

FIG. 4 is the shifts display screen setting out scheduled allocations for each of the particular locations;

FIG. 5 is an input screen for creating new rosters; and

FIG. 6 is an illustration of an actual hours master list report.

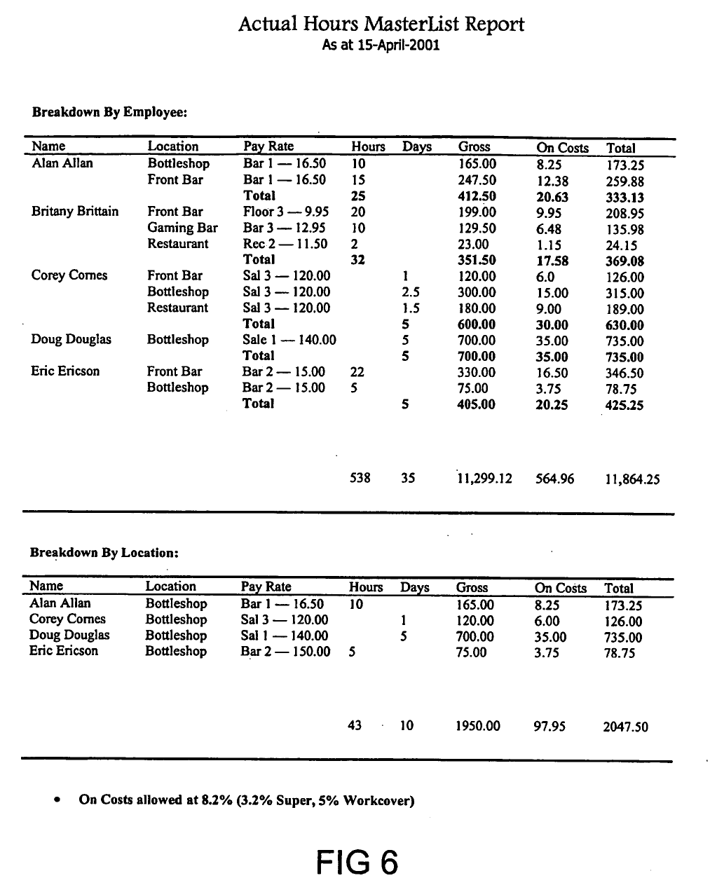

### BEST MODE FOR CARRYING OUT THE INVENTION

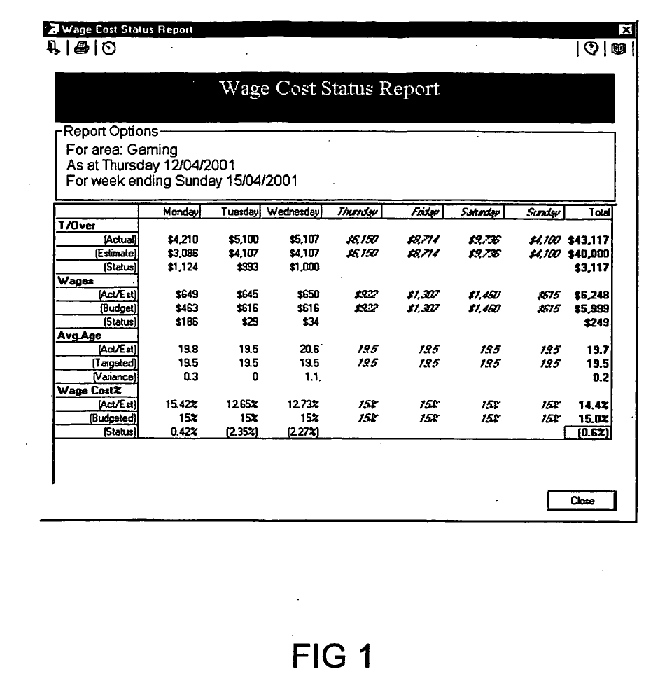

Referring in detail to the illustrations and in particular to output screens resulting from the computer program of the embodiment when in an appropriate computer with a visual output display and data input keyboard. Reference is first made to FIG. 1 where there is shown here over a selected period of time, and in this case this is a week, listed as Monday to Sunday, each of the actual turnover, actual wages that are incurred, average age and then percentage cost historic actual and predicted.

In FIG. 1, it will be seen that these are shown as historic actuals for Monday, Tuesday and Wednesday and then these revert to predicted for Thursday, Friday, Saturday and Sunday.

The predictions come from settings previously installed which are selected so that if met then budgets will be met as appropriate.

A significant factor in this layout is the fact that the cost of an employee in certain circumstances relates directly to his or her age so that anyone 21 years and over has the same wage cost.

Accordingly, if the average age within an allowable variable range, that is perhaps 16 to 21 years, can be kept lower, then there are savings to be made.

As can be seen in the actual examples, actual was 19.8 years whereas targeted was 19.5 years for the Monday which has a 0.3 variance.

This resulted in a wage cost percentage being 0.42% above budget.

For the Tuesday, there were slightly higher turnover figures which significantly exceeded estimates, while wages stayed fairly constant.

This resulted in them coming under budget by 2.35% as far as wage costs were concerned.

At the end of the week, there were consolidated figures and as can be seen at the bottom right hand, consolidating both actual plus estimates, there is a suggested below budget figure of 0.6%.

This then provides a very powerful tool for firstly testing various rostering arrangements, and it also saves a huge amount of time in finding the best combinations available, both from an availability and from a cost point of view.

It is in this case then, there are means to allocate personnel and very quickly test the question as to how these then will affect costs, and particularly how these can be tested in various ways, while getting a very rapid predicted result.

The further advantage is the fact that once a week or perhaps a month or any other selected period is started, there can be both the actual and predicted figures which together are used to provide a combined result and ongoing estimate as to how close to intended results the person affecting the roster is getting.

Further, if the manager is the person in charge of the roster, then his superior can from time to time monitor any warnings and can then offer assistance or change the criteria if necessary very quickly given the speed within which the costs can be picked up.

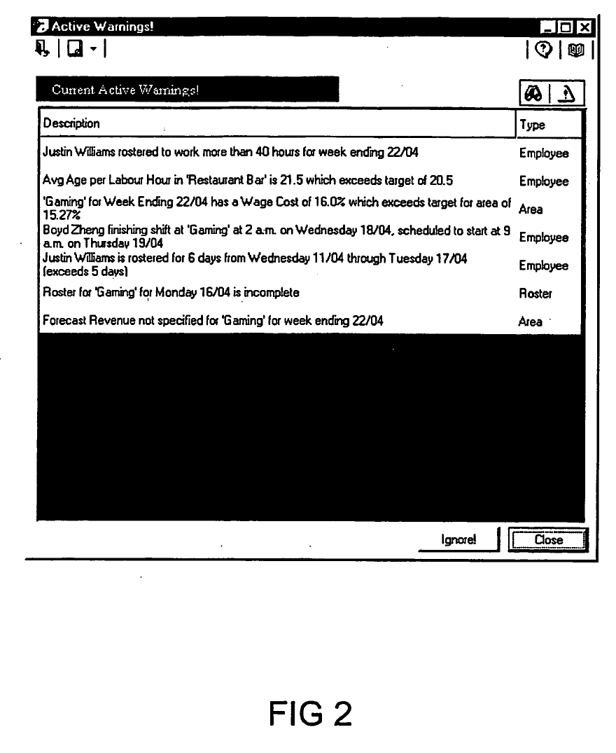

In FIG. 2, this then is an output screen generated by having ranges of acceptable numbers within the computer generating appropriate warnings.

For instance, the second warning has picked up the fact that an average age per labour hour in the restaurant bar is 21.5 years which exceeds the target of 20.5 years.

The third warning relates to wage costs of 15% which exceeds target for area of 15.27%.

The general warnings include other scheduling rostering warnings but insofar as the financials are concerned, it illustrates how these warnings within selected criteria can be provided and can be kept active on a selected basis.

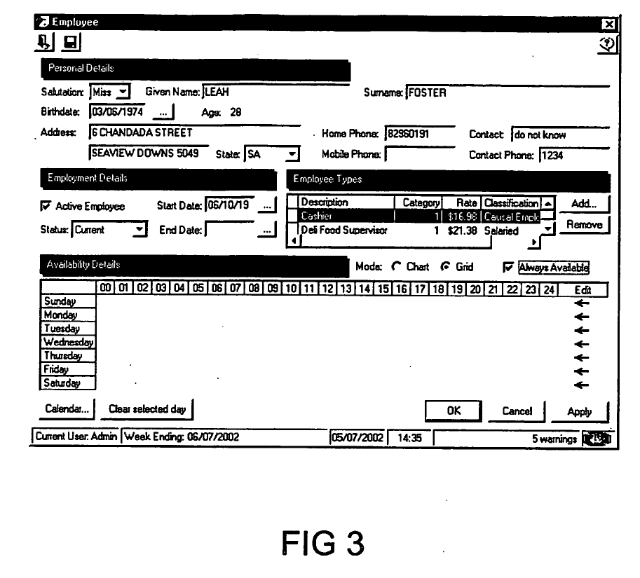

FIG. 3 is the employee input personal details screen and inputs into a general database of the computer various details identifying the employee, the wage as far as the age classification is concerned, competency and then availability hours.

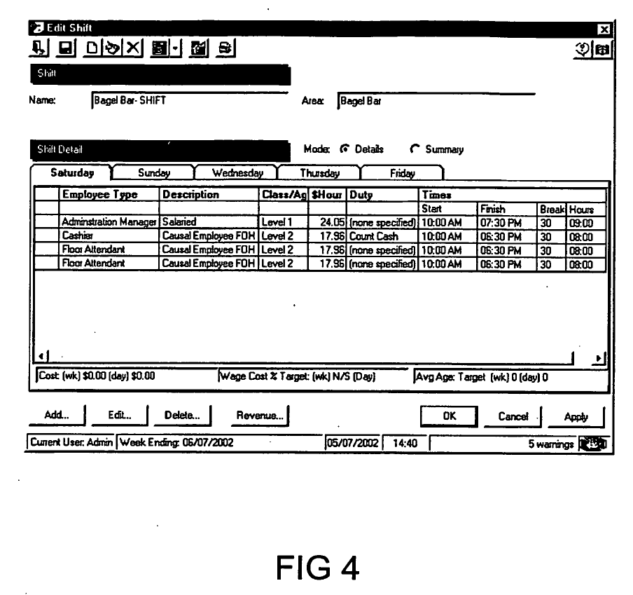

FIG. 4 is the display of shifts together with a summary of the results from such shifts, for instance the average age being achieved, the target age being sought, wage costs as a percentage of total sales and the target wage cost as a percentage of total sales.

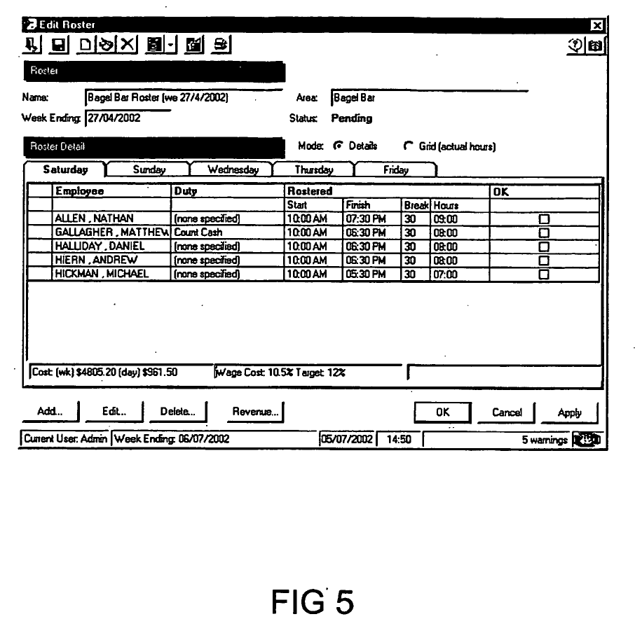

In order to create new rosters, there is an input screen which is shown in FIG. 5 where again each of the employees selected are then listed with their appropriate specific identifications and the start and finish times, breaks and actual hours are then input or recorded as appropriate.

It is of course these figures that are then used by the other screens as appropriate.

Finally, there is a printout able to be generated of any of the screens or other data which will include an output which is an actual hours master list report at the end of any period both in relation to employee in the one case and location in the other.

Again, this is identified in relation to costs which relate to individual per unit hours, cost per employee, on costs associated with each employee and totals for eventual consolidation.

What has now been described is the way that a computer program can be used to provide very strong assistance to those who are responsible for rostering and especially those who roster in order to keep costs contained as much as possible.

The programming behind the program itself is in accordance with conventional programming techniques in order to achieve the results described.

A conventional program such as Microsoft Windows NT has been used and programmed to provide these results.

What is of relevance then is that rather than merely providing scheduling assistance in the sense of filling time slots in a schedule for individuals there is provided a tool that allows for scheduling in a conventional sense with however the added feature that there is a monetary consequence output that is provided. It is of interest that the age of the person that might be placed in a particular shift might be very critical but other factors may be more relevant e.g. the number of people on a particular shift and the actual allocation of hours for each employee.

By having a what if facility so easily available then there can be and in practice is now found to be potential for significant savings and much better scheduling and achievement of profits.

1. A computer program for use in a computer such that when in a computer with a visual display unit and data entry means there are means in the computer to store a wage cost per unit of time for each of selected employee or contracted personnel, and an output screen available and means to effect calculations so that there will be displayed on the display unit in accord with input data, actual value of sales on a unit of time basis for each of at least one past day, and the cost of wages incurred by reason of a schedule of personnel scheduled in the program as a result of input from a user.

2. A computer program as in claim 1 further characterized in that there is available for a further at least one day in the future-an estimate of the cost of wages if scheduled allocations are used.

3. A computer program as in claim 1 further characterized in that there is, in relation to the display unit, an extent to which a wage cost result has achieved in the one case, and could achieve in the other, a budget prediction these being then for historic sales and for predicted sales for selected ranges of time.

4. A computer program as in claim 2 further characterized in that it is programmed to effect calculations in relation to preset limits such that if a result is below a budget expectation then there will be a warning message on a further available display screen.

5. A computer program as in claim 4 further characterized in that the program is arranged to provide and calculate any budget predictions both as a direct cost and as a percentage of sales.

6. A computer program as in claim 5 further characterized in that the program provides as an available output a cost for a roster period not only by area or department, but also a total for an entire business.

7. A computer program as in claim 6 further characterized in that the program captures and stores rosters completed at the end of their period.

8. A computer program as in claim 7 further characterized in that it is further adapted such that when a history is built up, the historical information can be viewed and be used for comparison purposes.

9. A computer program as in claim 8 further characterized in that the program is adapted to facilitate setting up rosters to reflect a desired average age consistently over financial periods.

10. A computer program as in claim 9 further characterized in that the program value of sales as both monetary value and percentage of value of wage cost.

11. A computer program as in claim 10 further characterized in that the program further includes means to provide either as a visual display output or a print output, at any stage, daily results achieved together with the budgeted outcome forecast for a selected period.

12. A computer program as in claim 11 further characterized in that the program is further adapted to effect accessible data records to include employee or contractor details which includes as applicable for each person information for that person relating to availability, annual leave, pay rate per unit of time, age, demographic details and areas of competency.

13. A computer program as in claim 12 further characterized in that the program is further arranged to provide that either click and drag timelines in a chart view or allocated times in grid view are available.

14. A computer program as in claim 13 further characterized in that the program is further arranged so that as shifts are built, cost of wages details are displayed.

15. A computer program as in claim 14 further characterized in that it is further arranged such that when a schedule is being built there is an option for the user to display only employee or contractor lists in relation to employees or contractors available and qualified for the particular shift.

16. A computer program as in claim 15 further characterized in that if a selection list of available employees or contractors does not provide coverage, there is a manual override which can be used to view all available staff regardless of qualification.

17. A computer program as in claim 16 further characterized in that to create a roster for any given period, the user may choose from 1) a saved shift selection; 2) an existing roster either current or pending; or 3) a previously completed roster.

18. A computer program as in claim 17 further characterized in that there is a printout able to be generated which is an actual hours master list report at the end of any period both in relation to employee in the one case and location in the other.
